(19) United States
(12) Patent Application Publication
(10) Pub. No.: US 2010/0059548 A1
(43) Pub. Date: Mar. 11, 2010

(54) BEVERAGE DISPENSING APPARATUS WHEREBY OXYGEN-DEPLETED AIR IS PUMPED INTO A KEG

(75) Inventor: Jacob Smid, Drachten (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/527,435

(22) PCT Filed: Feb. 15, 2008
(86) PCT No.: PCT/IB08/50551

§ 371 Date: Aug. 17, 2009

(30) Foreign Application Priority Data
Feb. 20, 2007 (EP) 07102711.4

(51) Int. Cl. B67D 7/80; B67D 1/08; B65D 83/00

(52) U.S. Cl. 222/146.6; 222/152; 222/394

(57) ABSTRACT

A beverage dispensing apparatus for enclosing a keg (2) containing a beverage, comprising pumping means (7) for compressing air, and gas transport means (8) for transporting compressed gas from said pumping means (7) to the keg (2) for driving the beverage out of the keg (2) The beverage dispensing apparatus comprises a membrane (10) enveloping a space through which compressed air can pass, whereby oxygen can pass much faster through the membrane (10) than nitrogen can pass through the membrane (10), so that the percentage of oxygen in the gas that is transported to the keg (2) is reduced.

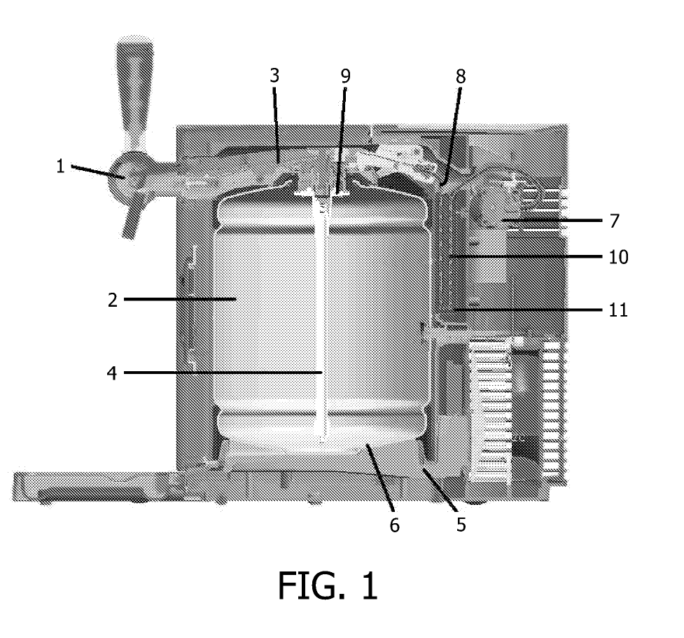

### FIELD OF THE INVENTION

The invention is related to a beverage dispensing apparatus for enclosing a keg containing a beverage, comprising pumping means for compressing air, and gas transport means for transporting compressed gas from said pumping means to the keg for driving the beverage out of the keg, and means for transporting the beverage from the keg to a dispensing tap for controlling the beverage output from the dispensing apparatus.

### BACKGROUND OF THE INVENTION

Such beverage dispensing apparatus is disclosed in US-A-2006/0131325. This publication describes a domestic beer dispensing apparatus, whereby a keg containing beer is located inside the apparatus. The dispensing apparatus is provided with means for cooling down the keg and for keeping the beer at drinking temperature. The dispensing apparatus is also provided with pumping means for pumping air into the keg in order to drive the beer to the dispensing tap of the apparatus. Inside the keg, the beer is contained in a container made of flexible plastic material, whereby the compressed air is supplied into the space between the flexible container and the inner wall of the keg. The plastic material of the container is relative thin in order to obtain the flexibility that is required for deforming the container while the beer is driven out of the keg.

Beer and other beverages can only be stored for a limited period of time. In general, the length of that period of time is shortened when the beverage is in contact with oxygen. Oxygen has a strong negative impact on the quality (taste) of the beverage and will limit the lifetime of the pressurized keg. Therefore, there is no oxygen in the keg as long as the keg is not opened for driving out the beverage. After the keg is opened, the beverage can be driven out of the keg by means of gas like nitrogen or CO₂ instead of air, in order to prevent the beverage from contact with oxygen and to maintain the quality of the beverage for a long period of time.

However, air is everywhere available and therefore it is an advantage to make use of air for driving the beverage out of the keg. Air approximately contains 79% of nitrogen and 20% of oxygen. In order to reduce the contact between the beverage and the air, the beverage can be stored in a flexible container inside the keg, whereby the compressed air is present outside the container. But even when the beverage is surrounded by a flexible container inside the keg, oxygen of the air will pass through the flexible material of the container after some time, in particular when it is relative thin plastic material. It is known that oxygen passes (diffuses) through the plastic material of the container up to ten times more faster than nitrogen. Hereinafter the expressions ‘diffuse’ and ‘diffusion’ shall be used where a gas passes through a permeable material.

### SUMMARY OF THE INVENTION

The object of the invention is a beverage dispensing apparatus for enclosing a keg containing a beverage, whereby air is compressed in order to drive the beverage out of the keg, and whereby the contact between the beverage and oxygen is reduced.

To accomplish with the object, the beverage dispensing apparatus comprises a membrane enveloping a space through which compressed air can pass, whereby the membrane has a higher permeability for oxygen than for nitrogen , so that the percentage of oxygen in the gas that is transported to the keg is reduced.

In this manner, oxygen can pass much faster through the membrane than nitrogen can pass through the membrane, so that the percentage of oxygen in the gas that is transported to the keg is reduced. When the beverage dispensing apparatus is in use, the gas in the gas transport means will be compressed, so that the diffusion of oxygen through the membrane can take place continuously, also during the relative long periods in which the dispensing tap is closed, while the pumping means provide for pressure in the gas transport means.

A membrane module comprising a space surrounded by a membrane, whereby oxygen in that space can pass through the membrane and whereby diffusion of gas having larger molecules through the membrane is limited, so that the percentage of oxygen of the gas in that space is reduced, is known, for example from U.S. Pat. No. 4,542,010. By means of such membrane module, the oxygen percentage in the compressed air can be reduced significantly, whereby a percentage of 0.5% of oxygen in the gas, or even less, can be achieved. By making use of such membrane in a beverage dispensing apparatus, a substantial reduction of oxygen exposure to the beverage can be obtained resulting in a significant increase of the lifetime of the beverage in the keg. In fact, both gases, oxygen and nitrogen will diffuse through the membrane. However, oxygen will diffuse much faster than nitrogen, so that the percentage of oxygen in the gas will decrease.

In a preferred embodiment of the invention, cooling means are present for cooling the keg, whereby at least a part of the gas transport means are cooled by said cooling means. Preferably, a part of the gas transport means are located near the cooling means. The difference in diffusion of oxygen and diffusion of nitrogen through the membrane is increased significantly by reducing the temperature of the membrane, and the cooling means for cooling the beverage can also be used for cooling down the gas transport means. So, by cooling the gas transport means, a lower percentage of oxygen in the gas can be achieved.

Preferably, the gas transport means comprise a tube-like membrane, whereby compressed gas is transported through the tube-like membrane from the pumping means to the keg. In the existing beverage dispensing apparatus the tube for transporting compressed air from the pumping means to the keg can be replaced by the tube-like membrane, whereby the tube-like membrane can be made much longer than the existing tube and whereby a major portion of the tube-like membrane can be located near the cooling means of the beverage dispensing apparatus. Thereby, the existing design of the beverage dispensing apparatus can be maintained.

In a preferred embodiment, the gas transport means comprise a number of hollow membrane fibers in parallel relation, through which fibers compressed gas is transported. A membrane module whereby the membrane consists of hollow fibers is described in WO-A-2006/009449. A hollow fiber membrane module can have a relative small dimension, so that it easily can be present inside the beverage dispensing apparatus. Furthermore, a relative large membrane surface can be obtained, whereby the contents of the space enveloped by the membrane is relative small.

### BRIEF DESCRIPTION OF THE DRAWING

The invention will now be further elucidated by means of a description of an embodiment of a domestic beer dispensing apparatus for enclosing a keg containing beer comprising gas transport means for transporting compressed gas to the keg, whereby the gas transport means comprise a membrane enveloping a space through which compressed gas can pass, and whereby the percentage of oxygen in the gas supplied to the keg is reduced. Thereby is made reference to the drawing comprising one figure, showing a vertical sectional view of a domestic beer dispensing apparatus.

### DETAILED DESCRIPTION OF THE DRAWING

The embodiment shown in the figure is a domestic beer dispensing apparatus, but a similar apparatus can be used for dispensing other carbonated and/or alcoholic beverages. The shown apparatus comprises a tap 1 in order to control the outflow of the dispensed beer. The tap 1 is connected with the keg 2 by means of a conduct 3. The keg 2 is surrounded by the dispensing apparatus. Inside the keg 2 is a conduct 4 extending from the top of the keg 2 to the bottom of keg 2. The conduct 4 is connected with the conduct 3, so that the beer in the keg 2 can flow from the bottom of the keg 2 to the tap 1, in order to be dispensed.

When the tap 1 is opened, the beer is driven out of the keg 2 because of the presence of compressed gas in the keg 2 above the beer. In order to limit the contact between the beer and the gas, the beer can be enveloped in a flexible container of thin plastic material (not shown in the figure). Thereby, the conduct 4 passes through an opening in the flexible container.

The dispensing apparatus is furthermore provided with a cooling device 5 for cooling the beer in the keg 2 when keg 2 is placed in the dispensing apparatus. Thereby, the cooling device 5 contacts the keg 2 at the bottom 6 of keg 2, so that the beer is effectively cooled from below.

The gas pressure in the keg 2 is established by means of an air pump 7, pumping air from the environment of the dispensing apparatus in the gas transport means 8 for supplying compressed gas to the keg 2. The gas transport means 8 are connected with the inside of the keg 2 by means of a one-way valve 9 near the location where the conduct 3 is connected with the conduct 4 inside the keg 2.

In order to reduce the percentage of oxygen in the gas supplied to the keg 2, the beverage dispensing apparatus, and in this embodiment its gas transport means 8, comprise a membrane enveloping the space through which the gas is transported to the keg. In the described embodiment, the gas is flowing through a tube-like membrane, being a tube, whereby the wall of the tube is the membrane through which oxygen can diffuse. The tube-like membrane 10 is located in a space 11, which space 11 is cooled by the cooling device 5, so that at least a part of the tube-like membrane 10 is cooled in order to improve the diffusion of oxygen through the wall of the tube-like membrane 10 compared to the diffusion of nitrogen.

A small opening is present to keep the space 11 where the tube-like membrane 10 is present, at the environmental air pressure, so that the diffused oxygen can leave the space 11. In the figure, the gas transport means 8 are shown as a tube-like membrane 11, however, as an alternative, the space 11 may contain a hollow fiber membrane module comprising a number of hollow fibers in parallel relation, through which fibers compressed gas is transported.

The described embodiment is only an example of a beverage dispensing apparatus according to the invention. Many other embodiments are possible, for example embodiments with a flat sheet membrane or any other kind of membrane.

1. A beverage dispensing apparatus for enclosing a keg (2) containing a beverage, comprising pumping means (7) for compressing air, and gas transport means (8) for transporting compressed gas from said pumping means (7) to the keg (2) for driving the beverage out of the keg (2), and means (3) for transporting the beverage from the keg (2) to a dispensing tap (1) for controlling the beverage output from the dispensing apparatus, characterized in that the beverage dispensing apparatus comprises a membrane (10) enveloping a space through which compressed air can pass, whereby the membrane has a higher permeability for oxygen than for nitrogen , so that the percentage of oxygen in the gas that is transported to the keg (2) is reduced.

2. A beverage dispensing apparatus as claimed in claim 1, whereby the gas transport means (8) comprise said membrane (10).

3. A beverage dispensing apparatus as claimed in claim 1, whereby cooling means (5) are present for cooling the keg (2), characterized in that at least a part of the gas transport means (8) are cooled by said cooling means (5).

4. A beverage dispensing apparatus as claimed in claim 1, characterized in that the gas transport means (8) comprise a tube-like membrane (10), whereby compressed gas is transported through the tube-like membrane (10) from the pumping means to the keg (2).

5. A beverage dispensing apparatus as claimed in claim 1, characterized in that the gas transport means (8) comprise a number of hollow fibers in parallel relation, through which fibers compressed gas is transported.
